(19) United States
(12) Patent Application Publication
(10) Pub. No.: US 2001/0012733 A1
(43) Pub. Date: Aug. 9, 2001

(54) Device for retrofitting a computer

(76) Inventors: Hartmut Schmidt, Grossbottwar (DE); Stefan Custers, Westerlo (BE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/760,738

(22) Filed: Jan. 17, 2001

(30) Foreign Application Priority Data
Jan. 18, 2000 (DE) 100 01 815.7

(51) Int. Cl. H01R 25/00; H01R 27/02; H01R 31/00; H01R 33/88; H01R 33/90; H01R 33/92; H01R 33/94

(52) U.S. Cl. 439/638

(57) ABSTRACT

The invention relates to a device for the retrofitting of a computer with commercial plug-in units (1), wherein the computer is provided with plug-in slots whose format does not correspond to that of the commercial plug-in units (1). A retrofitting device of this kind is characterized in that a plug-in unit carrier (2) is provided with an open-edged recess for the accommodation of the commercial plug-in unit (1), where the plug-in unit carrier (2) comprises interface means (3 and 5) for adapting the inputs and outputs of the plug-in unit (1) to the inputs and outputs of the plug-in slot and the plug-in unit/carrier assembly substantially corresponds to the format of the plug-in slot.

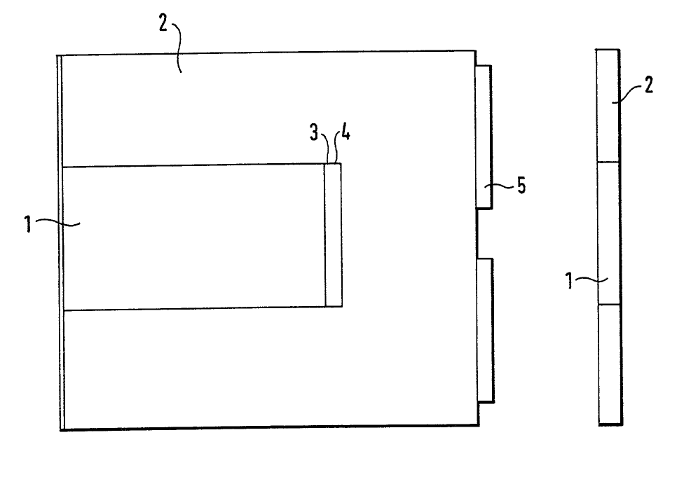

The invention relates to a device for retrofitting a computer with commercial plug-in units, wherein the computer is provided with plug-in slots whose format does not correspond to that of the commercial plug-in units. The progressive development of computer technology is giving rise to increasingly frequent compatibility difficulties in the retrofitting of hardware- and/or software modules. The interface terminals and/or external dimensions of the plug-in slots provided for this purpose on existing computers no longer conform to the connection requirements of commercial plug-in units. Older computers, which however are still functional and outstandingly suitable for their purpose of use, for example in the telecommunications sector, can no longer be retrofitted with larger memories, updated software versions and other applications. Modern standard-bus systems and formats such as VME or compact PCl cannot be integrated in existing computer systems. The new generation of COTS (commercial off-the-shelf) format plug-in units is characterised by a smaller structural form and a different interface.

The object of the invention is to provide a retrofitting device of the type defined, which enables given computer plug-in slots to be fitted with plug-in units whose format and interface do not correspond to those of the slots.

In accordance with the invention, this object is achieved in that a plug-in unit carrier is provided with an open-edged recess for the accommodation of the commercial plug-in unit, where the plug-in unit carrier comprises interface means for adapting the inputs and outputs of the plug-in unit to the inputs and outputs of the plug-in slot, and the plug-in unit/carrier assembly substantially corresponds to the format of the plug-in slot. A mechanical and interface adaptation between a given computer plug-in slot and a commercial plug-in unit is obtained in this way. To enable existing computers to be retrofitted with plug-in units with different formats and interfaces, plug-in unit carriers are interposed. The new plug-in unit is preferably mounted centrally in the substantially U-shaped plug-in unit carrier, the plug-in unit being inserted into a recess of the plug-in unit carrier, resulting in smooth, continuous lateral surfaces of the plug-in unit/carrier assembly. Only one computer plug-in slot is required for the plug-in unit/carrier assembly. More powerful or entirely new software can thus easily be retrofitted, it being possible to re-use the plug-in unit carrier for other plug-in units containing even better software or new or improved applications. The life of technically complex and very costly basic systems can be considerably extended by the possibility of simple retrofitting with the most up-to-date peripheral modules. Additionally, the introduction onto the market of new format- and interface standards for computer plug-in units is considerably simplified in this way.

The invention will be explained in detail in the following in the form of an exemplary embodiment illustrated in the drawing.

The FIGURE is a schematic diagram of a plug-in unit/carrier assembly in a side view and end view. A standardized COTS plug-in unit 1 here is engagingly inserted in a plug-in unit carrier 2. The substantially U-shaped plug-in unit carrier 2 is equipped inside its plug-in opening with interface means 3 which correspond to the standard-bus interface 4 of the COTS plug-in unit 1. Via a data-bus system or other adaptive elements, the interface means 3 of the plug-in unit carrier 2 are connected to a bus interface 5 on the peripheral side of the plug-in unit carrier 2 facing towards a plug-in slot of a computer. This bus-interface 5 in turn corresponds to the plug-in slot interface. The software data or applications contained by the COTS plug-in unit 1 can thus also be used for computers with plug-in slots of an older type. The mechanical adaptation of the external dimensions can be achieved by the structural shape of the plug-in unit carrier 2, such that smooth, quasi continuous lateral surfaces of the plug-in unit/carrier assembly are formed. Here differences in thickness can be compensated by a pocket-like plug-in opening of the plug-in unit carrier 2. The plug-in unit/carrier assembly can be designed as a compact retrofitting unit. However a two-part embodiment is also possible, in the case of which a plug-in unit carrier 2 can be fitted with different COTS plug-in units 1 as required by the computer user.

The invention is not limited to the above described exemplary embodiment. Rather, a number of variants are conceivable which utilize the features of the invention albeit in a basically different type of design.

1. A device for retrofitting a computer with commercial plug-in units (1), wherein the computer is provided with plug-in slots whose format does not correspond to that of the commercial plug-in units (1), characterised in that a plug-in unit carrier (2) is provided with an open-edged recess for the accommodation of the commercial plug-in unit (1), where the plug-in unit carrier (2) comprises interface means (3 and 5) for adapting the inputs and outputs of the plug-in unit (1) to the inputs and outputs of the plug-in slot and the plug-in unit/carrier assembly substantially corresponds to the format of the plug-in slot.
